(19) United States
(12) Patent Application Publication
(10) Pub. No.: US 2020/0221193 A1
(43) Pub. Date: Jul. 9, 2020

(54) Software-Defined Redundancy in a Passive Optical Network

(71) Applicant: FiberRise, LLC, Madison, AL (US)

(72) Inventor: Chad Anthony Dieselberg, Madison, AL (US)

(73) Assignee: FiberRise, LLC, Madison, AL (US)

(21) Appl. No.: 16/731,182

(22) Filed: Dec. 31, 2019

Related U.S. Application Data
(60) Provisional application No. 62/788,011, filed on Jan. 3, 2019.

(51) Int. Cl. H04Q 11/00

(52) U.S. Cl. CPC H04Q 11/0005; H04Q 11/0067; H04Q 2011/0088; H04Q 2011/0081; H04Q 2011/0043

(57) ABSTRACT

A software-defined redundant passive optical network (SD RPON) system having a passive optical network (PON) provider's server with an access network. The access network has a primary path to an optical line terminal (OLT) connected to an optical network terminal (ONT), wherein the ONT is connected to a customer's equipment to receive a PON signal and PON services. The access network also has one or more protection paths extending to another OLT connected to the ONT. An auto-detection system monitors PON signal transmission through the access network and an auto-assignment system assigns an ONT to the customer through using a customer's unique identifier. The SD RPON system automatically moves a customer from an existing ONT to another ONT if PON signal transmission fails through the existing ONT and serves a diverse path protection, while offering tremendously simplified and time-saving disaster recovery.

### CROSS-REFERENCE TO RELATED APPLICATIONS

This patent application claims the benefit of U.S. Provisional Patent Application No. 62/788,011 filed on Jan. 3, 2019, the contents of which are incorporated herein by reference.

### FIELD OF THE INVENTION

This invention relates to passive optical networks that provide point-to-multipoint optical fiber distribution to deliver high bandwidth services to customers and, more particularly, to a passive optical network having software-defined redundancy that provides a diverse protection path for alternate access to the network.

### BACKGROUND OF THE INVENTION

A passive optical network (PON) is a point-to-multipoint fiber distribution architecture that combines access aggregation, broadcast, and statistical multiplexing techniques to deliver very high bandwidth services to customers. FIG. 1 describes the PON 10 design as it currently exists. PON 10 was developed to reduce or eliminate active electronics in the outside plant, decreasing the cost and complexity of operations and maintenance for the service provider. PON 10 utilizes multiple wavelengths to transmit and receive data, transmitting data in the downstream direction while utilizing a Time Division Multiple Access (TDMA) technique in the upstream direction. A PON service provider provides a PON network 11 to an optical line terminal (OLT) 12. A single feeder fiber 13 is used to carry traffic longer distances from a central office access node 14 to an area serving homes and businesses. An optical splitter 15 then divides the optical signal among many shorter distributions or drop fibers 16 to deliver services to an optical network terminal (ONT) 17 at a customer's premises, wherein the ONT 17 is connected to the customer's computer equipment 18.

PON has evolved through many iterations of electronics over the past couple of decades. An attractive feature of the PON fiber access architecture is that the optical plant can remain unchanged while the electronics at either end of the optical plant can be updated continuously. PON electronics were originally developed around the Asynchronous Transfer Mode (ATM) protocol and operated at downstream speeds of 622 kbps. Current PON networks are operating at 10 Gigabit downstream rates

Redundant or resilient ring architectures have been in use for many years to provide alternate data paths in the event of a transmission line fault or equipment failure. Redundant or resilient designs typically incorporate a protection ring 20 architecture, a switched line protection 21 architecture or combination of the two as shown in FIG. 2. These network architectures developed originally around circuit-switched time division multiple (TDM) environments and evolved into ATM and packet-based environments in use today. In these architectures, the equipment detects a failure (shown by X) and provides a failover mechanism to maintain the delivery of services through an alternate path between the source and destination of the interconnected access nodes 22 (1-4). In a ring architecture 20, data would take the path (shown by arrow 23) not affected by a fault occurring in one direction of the ring. In a protection architecture 21 line switching scheme, an access node 22 (node 4) would switch from a primary port 24 on the node 22 to a separate protection port 25 to circumvent either a physical port failure or path failure. UPSR (unidirectional path switching rings), BLSR (bidirectional line switch rings) and automatic protection switching (APS) are examples of redundant protection schemes used for many years.

Conventional protection and redundancy schemes tend to be vendor-specific and static. APS involves switching to another port on the same access system. Nodes in a ring-based architecture must be of the same vendor or even same model, and once defined and implemented, remain locked in place until the physical plant is changed. Mission critical applications require high availability, so redundancy is the best way to provide service assurance. Electric power distribution, for example, is becoming increasingly sophisticated in terms of its monitoring and switching capabilities. A technique that provides a significant improvement in reliability and flexibility of data exchange, control and monitoring in a PON is desirable.

Traditional provisioning of PON services involves ONT port pre-assignment. Upon a request from a customer for service, the PON service provider will assign the next available ONT port on the access system to that customer and manually create associations between the customer, the services, and the equipment assignments in a tracking system, typically a billing system or some plant inventory system. When installation occurs, the installer will establish service delivery using the equipment assignments given, or otherwise make changes in the assignments should it be necessary to make the service function. Such changes must be communicated back into the record keeping system, creating the possibility of inaccuracies due to human error or miscommunication. If the customer must be reassigned to another ONT port or system due to a move or a catastrophic weather event, for example, the move action requires record accuracy in both the ONT port from which the service is being removed as well as the ONT port to which the service is being reassigned. This process can be both time-consuming and vulnerable to error and improvement in the process is desirable.

### SUMMARY OF THE INVENTION

This invention is a software-defined redundant passive optical network (SD RPON) system implemented as a software-driven control system mounted on a network server connecting to the PON access network. A PON access network is described as connecting an optical line terminal (OLT) in a primary access node via a feeder fiber extending from the OLT in the primary access node to a primary splitter, which may directly feed ONT units through distribution fiber or cascade through additional splitters, wherein the ONT is configured for connection to customer equipment to receive PON services. The Redundant PON specified as the invention, or RPON, architecture uniquely provides both primary and protected gigabit speed fiber paths connected to a single ONT through a 1×2 splitter, creating two paths, each path returning to separate OLT PON ports through the splitter(s) and feeder fiber. When a loss of signal or similar alarm from the customer's ONT or the OLT is detected by the server software system controlling the redundancy switching mechanism, the primary path to the primary OLT is toggled to the OFF state and the protect path to the protect OLT is toggled to the ON state, thereby restoring communication connectivity to the ONT through the alternate path. The criteria for switching is configurable for various conditions and scenarios.

This invention relies upon an additional method of auto-assigning passive optical network (PON) equipment to the access network and services to an endpoint. This method is used to automatically assign an ONT to the network and configure services to the ONT. This method utilizes automatic discovery techniques to record the exact location of an ONT on a network and the services assigned to it. It is this record of the ONT assignment that will be utilized to initiate the redundancy switching operation specified by this invention. In the ONT automatic assignment technique, an ONT is connected to the PON provider's access network. The connecting of the ONT is automatically detected with the auto-detection system, and a data path is provisioned between the ONT and a provisioning portal. This provisioning portal is accessed through the ONT over the PON access network. A unique identifier is entered into the provisioning portal and submitted to the system software server, which will return the provisioning associated with this unique identifier. The system software server provisions the customer's ONT and the PON access network and connects the customer's ONT to the PON services. The customer's equipment is connected to the customer's ONT and the PON services are activated for the customer.

An additional feature of the invention specifies a “lock” state for the path that failed and caused the redundant switch action to occur. The “lock” state prevents the system from switching back and forth between the two paths should a loss of signal or service or other alarm conditions cause an unstable network state condition. When the fault that caused the error condition is corrected, the path that experienced the problem is automatically configured as the protect path and can be manually restored to service.

An advantage of the SD RPON system is that it serves not only diverse path protection but offers tremendously simplified and time-saving disaster recovery.

Another advantage is no assignment knowledge is required because the SD RPON system will recognize the customer termination equipment and will automatically begin a remapping process to restore service to every customer previously connected to a failed access node.

Another advantage is a customer identifier that is associated with the equipment residing at the customer premises, the desired services maintained by the billing system, and the records maintained by the auto-assignment system

Another advantage is the ability to move a customer from a first ONT port to a second ONT port, whether the second ONT port resides on the same pathway as the first ONT port, on a different pathway within the access network, or on a pathway in a completely different access network altogether.

### BRIEF DESCRIPTION OF THE DRAWINGS

FIG. 1 is a block diagram of a prior art passive optical network design.

FIG. 2 is a block diagram of prior art redundant or resilient designs of passive optical network protection architecture.

FIG. 3 shows a block diagram of the software-defined redundant passive optical network (SD RPON) system of this invention.

FIG. 4 is a flow chart illustrating the method of auto-assigning PON services to a new customer.

FIG. 5 FIG. 5 is a flow chart illustrating a method of re-assigning a customer from one ONT to another.

FIG. 6 is a block diagram of a customer's computer system.

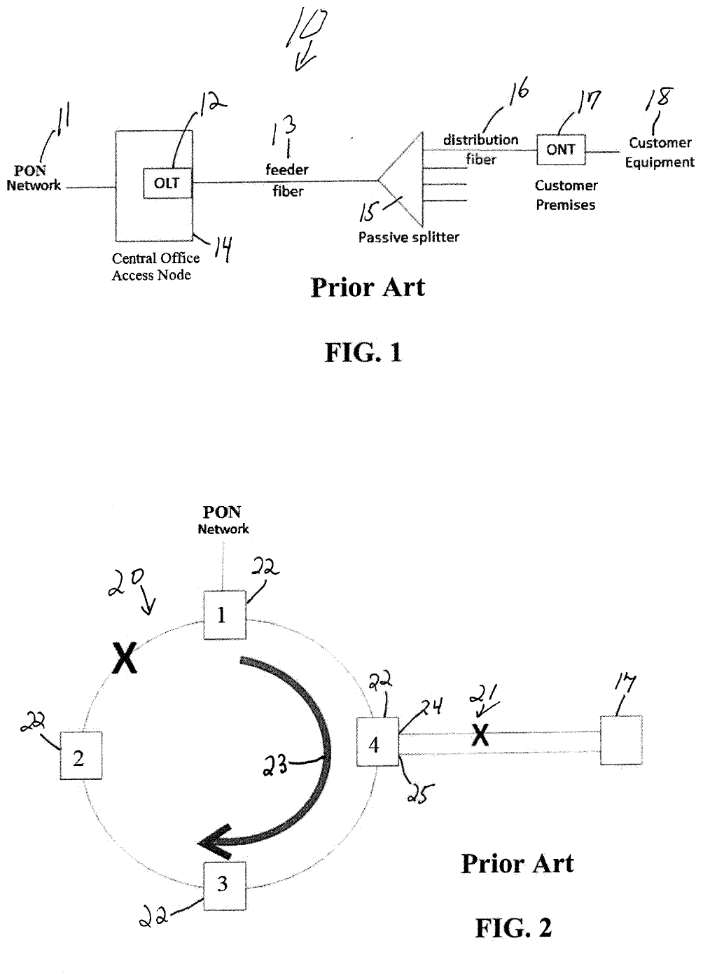

### DETAILED DESCRIPTION OF THE INVENTION

While the following description details the preferred embodiments of the present invention, it is to be understood that the invention is not limited in its application to the details of arrangement of the parts or steps of the methods illustrated in the accompanying figures, since the invention is capable of other embodiments and of being practiced in various ways.

Below is a list of acronyms used in the present disclosure.

### API Application Programming Interface

### APS Automatic Protection Switching

### ATM Asynchronous Transfer Mode

### BLSR Bidirectional Line Switched Rings

### GIS Geographical Information System

### GPON Gigabyte Passive Optical Network

### LOS Loss of Signal/Service

### OLT Optical Line Terminal

### ONT Optical Network Terminal

### PN DPS Private Network Discovery and Provisioning System

### PON Passive Optical Network

### RPON Redundant Passive Optical Network

### SD RPON Software-Defined Redundant Passive Optical Network

TDM Time Division Multiple (access)

### UPSR Unidirectional Path Switched Ring

This invention is a software-defined redundant passive optical network (SD RPON) system implemented on a PON provider's server and a PON access network. The PON access network has a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to customer equipment to receive PON services. The PON access network also has one or more protection paths, each protection path extending to an OLT in a protection access node, a feeder fiber extending from the OLT in the protection access node to a protection splitter, two or more distribution fibers extending from the protection splitter to the two or more secondary splitters. An auto-detection system in the PON provider server monitors PON signal transmission through the PON access network and automatically detects a connection of an ONT to the PON access network and to the customer's equipment. The ONT automatically transmits information, including the customer's unique identifier, from an installer to a provisional portal in the PON provider's server and PON services are provisioned to the ONT.

An auto-assignment system in the PON provider's server assigns an ONT to the customer through the PON access network and reassigns an ONT to the customer through the PON access network or the Internet. When the primary path is in an ON configuration, a PON signal is transmitted to the secondary splitter through the primary path, the protection path is in an OFF configuration, and the PON signal is not transmitted to the secondary splitter through the protection path. When the primary path is in an OFF or disrupted configuration, a PON signal is not transmitted to the secondary splitter through the primary path, the protection path is in an ON configuration, and a PON signal is transmitted to the secondary splitter through the protection path.

This invention provides a method of auto-assigning passive optical network (PON) services to a customer. An ONT is provided to a customer and is connected to the PON provider server's PON access network. The connecting of the ONT is automatically detected with the auto-detection system and a data path is provisioned between the customer's ONT and a provisional portal by the PON provider's server. The provisional portal is accessed through the customer's ONT over the PON access network. The customer's unique identifier is entered on the provisional portal and submitted to the PON provider's server, requesting provisioning of the customer's ONT for PON services. The PON provider's server provisions the customer's ONT and the PON access network and connects the customer's ONT to the PON services. The customer's equipment is connected to the customer's ONT and the PON services are activated for the customer.

When a loss of signal from the customer's ONT is detected by the automatic detection system the protection path is automatically toggled to an ON position by the auto-assignment system. The automatic detection system discovers any distribution fiber that is not in a service mode and the discovered distribution fiber is automatically provisioned for the customer's ONT using the customer's unique identifier and the auto-assignment system.

The PON service provider's access network will incorporate a diverse protection path to provide an alternate means of access to the network. The alternate protection path will not be activated until the protection system detects a failure in the primary path. The protection PON service delivery no longer resides in the vendor-specific access system domain. Control for a failover event resides in the PON service provider's access network via a software-defined redundant PON system. This approach moves protection control into the world wide web system (cloud), allowing the PON access systems to be utilized simply as aggregation switches that report on the state and status of I/O ONT ports. Controlling redundancy in the cloud allows the PON network to become vendor agnostic, reducing access node limitations, complexity, and cost while providing “white box” solutions that reduce overall network capital expenses.

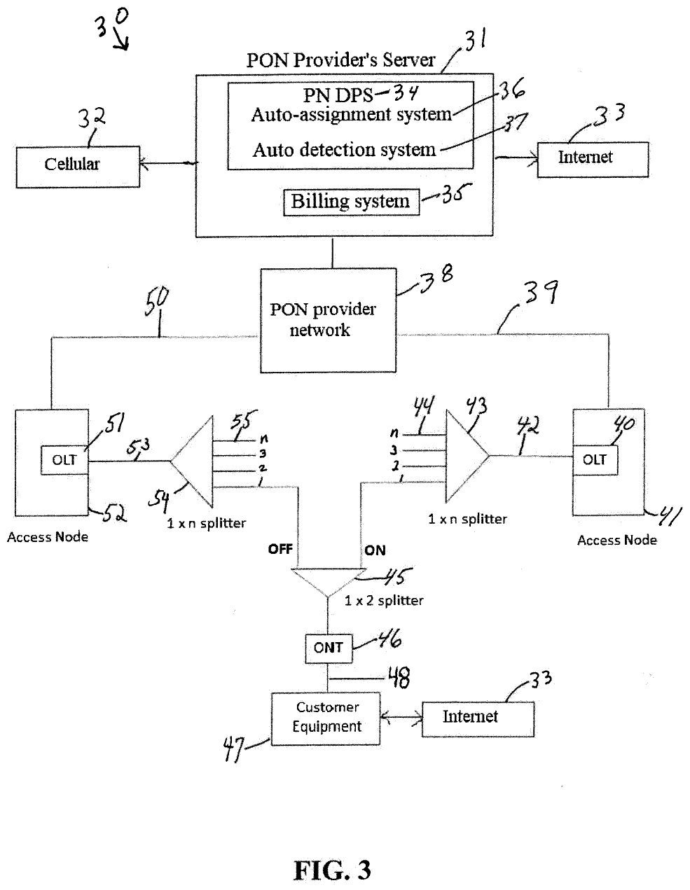

FIG. 3 shows a block diagram of the software-defined redundant passive optical network system 30 (SD RPON) of this invention. System 30 includes a PON service provider's server 31 which is connected to the cellular phone communication systems 32 and the worldwide web Internet system 33. The service provider's server 31 includes a private network discovery and provisioning system (PN DPS) 34 and a billing system 35. The PN DPS 34 is a coherent collection of management systems, networking components and web server functions to discover and provision devices attached to the PON service provider's access network 38. The web server 31 provides the “provisioning portal” used to activate devices and services. The PN DPS 34 consists of an auto-assignment system 36 and an auto-detection system 37. Server 31 also connects to the PON service provider's private access network 38. Network 38 has a primary path 39 which connects to an optical line terminal (OLT) 40 in a primary access node 41. The OLT 40 has a feeder fiber 42 that connects to a primary splitter 43. The primary splitter 43 provides two or more distribution fibers 44. The distribution fibers 44 each connect to a secondary splitter 45 that is connected to an optical network terminal (ONT) 46. The ONT 46 is connected to customer equipment 47 with ethernet connections 48. When PON services are provided to the customer equipment 47, the customer can connect to the Internet 33.

The network 38 also has a protection path 50 which connects to an OLT 51 in a protection access node 52. The OLT 51 has a feeder fiber 53 that connects to a protection splitter 54. The protection splitter 54 provides two or more distribution fibers 55. The distribution fibers 55 each connect to a secondary splitter 45 that is connected to an ONT 46. The primary path 39 is shown in an “ON” position and the protection path 50 is shown in an “OFF” position. Although only one protection path is shown, a plurality of protection paths with OLTs, protection access nodes, and feeder fibers can be configured to connect to a splitter 54.

The SD RPON network of this invention provides auto-assignment and auto-reassignment (ONT port swapping) of ONT ports to customers. These features simplify and automate the record keeping required for equipment and assignment changes that occur as a result of switchovers in the redundant network configurations. Auto-assignment capability in the SD RPON changes the current paradigm in ONT port assignments and the method for creating associations between a customer, the services, and the equipment delivering the services. In the auto-assignment approach, the only information that is required for provisioning an ONT port is a customer identifier and the services which are being requested. No special software is required of the network access system, making this technique vendor agnostic. Auto-assignment utilizes an intent-based configuration system that connects with the network access system through standard APIs to direct the provisioning of the various systems involved in the delivery of the desired services. The auto-assignment system may reside locally with the service provider's server or may be cloud-based, whichever meets the demands of the service provider.

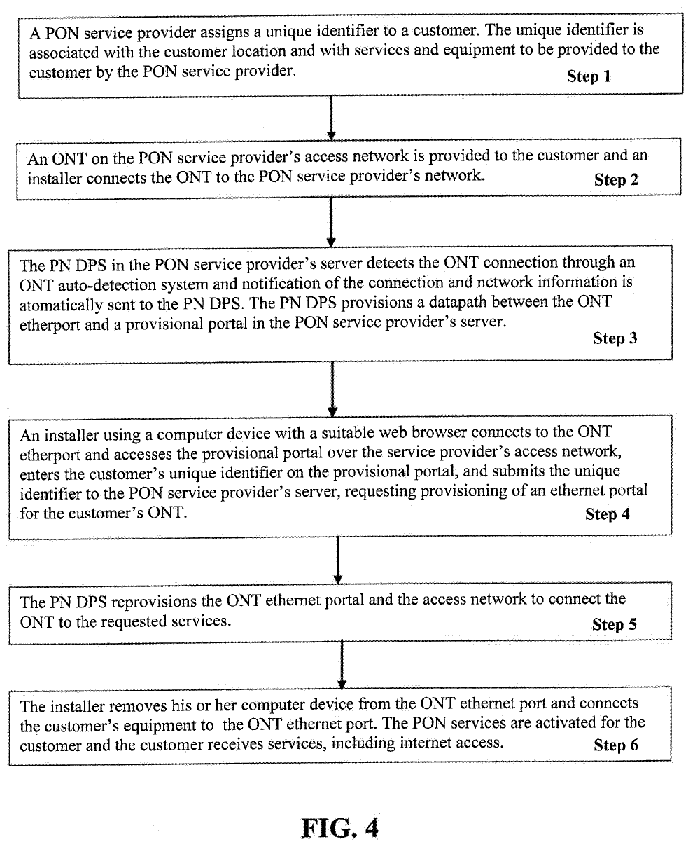

With the auto-assignment system in place, no equipment pre-assignment is necessary. FIG. 4 is a flow chart illustrating the method of auto-assigning PON services to a new customer. A PON service provider assigns a unique identifier to a customer. The unique identifier is associated with the customer location and with services and equipment to be provided to the customer by the PON service provider (Step 1). An ONT on the PON service provider's access network is provided to the customer and an installer connects the ONT to the PON service provider's network (Step 2). The PN DPS in the PON service provider's server detects the ONT connection through an ONT auto-detection system and notification of the connection and network information is sent to the PN DPS. The PN DPS provisions a data path between the ONT ethernet port and a provisional portal (walled garden or capture portal website) in the PON service provider's server (Step 3). An installer using a computer device with a suitable web browser connects to the ONT ethernet port and accesses the provisional portal over the service provider's access network, enters the customer's unique identifier on the provisional portal, and submits the unique identifier to the PON service provider's server, requesting provisioning of an ethernet portal for the customer's ONT (Step 4). The PN DPS re-provisions the ONT ethernet portal and the access network to connect the ONT to the requested services (Step 5). The installer removes his or her computer device from the ONT ethernet port and connects the customer's equipment to the ONT ethernet port. The PON services are activated for the customer and the customer has services, including internet access (Step 6).

An installation technician at the customer premises simply attaches an ONT to the PON service prover's access network, the ONT is automatically discovered, and the connection routed to the provisional portal. Using an ordinary browser on a smartphone, laptop or tablet, the installer enters the unique customer identifier that is known in the billing system and submits a web form with a single ‘click’ to the provisional portal. Using this approach in a standard GPON architecture or the SD RPON architecture, service can be activated as long as there is an acceptable level of light presented at the end of the distribution drop fiber at the home or business of the customer. There is no concern for being on the correct fiber, ONT port, or even access network as long as the access network is configured with auto-assignment. The auto-assignment system will automatically learn the equipment assignments and create associations between the equipment, services and customer.

The association established between the customer identifier and the equipment residing at the customer premises as well as the association between the customer identifier and the desired services maintained by the billing system and the records maintained by the auto-assignment system makes port swapping and redundancy of the SD RPON system possible.

The SD RPON system has the advantages of moving a customer from a first ONT port to a second ONT port, whether the second ONT port resides on the same pathway as the first ONT port, on a different pathway within the access network, or on a pathway in a completely different access network altogether. If a customer is moved from a first ONT port that is considered by the system to be ‘in service’ to a second ONT port considered to be in a ‘discovery’ mode, then the auto assignment system will recognize the customer premises equipment as an already existing service. Based on policies set by the SD RPON system, the auto-assignment system can re-assign the equipment and services to the second ONT port, delete assignments from the first ONT port, and automatically update the customer records to reflect the new assignments. No manual intervention is required to restore service to the customer or to update the customer's records.

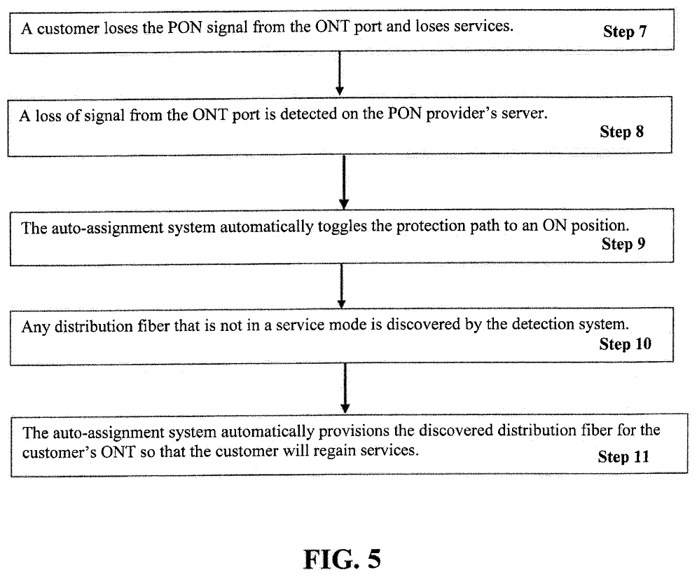

FIG. 5 is a flow chart illustrating a method of re-assigning a customer from one ONT to another. If a customer loses the PON signal from the ONT port and lose services (Step 7), a loss of signal from the ONT port is detected on the PON provider's server (Step 8). The auto-assignment system automatically toggles the protection path to an ON position (Step 9). Any distribution fiber that is not in a service mode is discovered by the detection system (Step 10). The auto-assignment system automatically provisions the discovered distribution fiber for the customer's ONT so that the customer will regain services (Step 11).

An alarm condition, such as a loss of signal or service at the customer's ONT, is the triggering event for the SD RPON system to respond. The alarm condition triggers the SD RPON system to toggle light in the protection path to an ON state. It is not necessary to provision equipment to the ‘discovery’ mode; any ONT that is not in an “in service” mode is by default in a “discovery” mode. Already known to the auto-assignment system, the customer's premise equipment will be recognized as part of an already existing service and will automatically be provisioned to a new ONT port along with the customer identifier and desired services. The customer records within the auto-assignment system are automatically updated and can be exported to external record keeping systems such as the billing system.

The SD RPON system serves not only diverse path protection but offers tremendously simplified and time-saving disaster recovery. For example, an entire access node system or Central Office could be lost to an act of nature such as flooding. With the auto-assignment and the SD RPON system residing in a cloud configuration, a recovery node could be quickly configured with appropriate network connections, and restoration occurs simply by connecting outside plant fibers to any ONT ports on the recovery access node. No assignment knowledge is required. The SD RPON system will recognize the customer termination equipment and will automatically begin a remapping process to restore service to every customer previously connected to a failed access node.

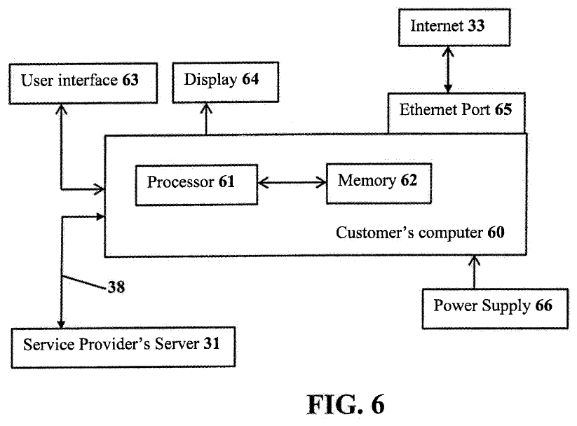

The SD RPON system can be implemented, in part, as a computer software program in any standard computer/processor/server system well known in the art. FIG. 6, for example, illustrates a customer's computer system 60 having a processor 61, memory 62, a user interface 63, a display 64, an ethernet port 65, and a power supply 66. The computer 60 can be connected to a service provider's server 31 through an access network 38 and to the Internet 33 through ethernet port 65. The service provider's server system 31 can use similar computer processing systems.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, PON services of the present invention can be provided over both the primary and protection pathways and can include voice (plain old telephone service (POTS) or voice over IP (VoIP)), data (typically Ethernet or V.35), video, telemetry (TTL, ECL, RS530, etc.), Internet Protocol Television (IPTV), RF video and/or Video on Demand (VoD).

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A software-defined redundant passive optical network system, comprising:
a) a passive optical network (PON) provider's server having a PON access network;
b) the PON access network having a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to a customer's equipment to receive PON signal and PON services;
c) the PON access network having one or more protection paths, each protection path extending to an OLT in a protection access node, a feeder fiber extending from the OLT in the protection access node to a protection splitter, two or more distribution fibers extending from the protection splitter to the two or more secondary splitters;
d) an auto-detection system in the PON provider's server that monitors PON signal transmission through the PON access network; and
e) an auto-assignment system in the PON provider's server that assigns an ONT to the customer through the PON access network using a customer's unique identifier.

2. The software-defined redundant passive optical network system of claim 1, wherein, when the primary path is in an ON configuration, a PON signal is transmitted to the secondary splitter through the primary path, the protection path is in an OFF configuration, and PON signal is not transmitted to the secondary splitter through the protection path and wherein, when the primary path is in an OFF or disrupted configuration, a PON signal is not transmitted to the secondary splitter through the primary path, the protection path is in an ON configuration, and a PON signal is transmitted to the secondary splitter through the protection path.

3. The software-defined redundant passive optical network system of claim 1, wherein the autodetection system automatically detects a connection of an ONT to the PON access network and the customer's equipment.

4. The software-defined redundant passive optical network system of claim 1, wherein the ONT automatically transmits information, including the customer's unique identifier, from an installer to a provisional portal in the PON provider's server and PON services are provisioned to the ONT.

5. The software-defined redundant passive optical network system of claim 1, wherein the auto-assignment system reassigns another ONT to the customer through the primary path or the protection path, over the PON access network or the Internet using the customer's unique identifier.

6. A software-defined redundant passive optical network system, comprising:
a) a passive optical network (PON) provider's server having a PON access network;
b) the PON access network having a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to customer equipment to receive PON services;
c) the PON access network having one or more protection paths, each protection path extending to an OLT in a protection access node, a feeder fiber extending from the OLT in the protection access node to a protection splitter, two or more distribution fibers extending from the protection splitter to the two or more secondary splitters;
d) an auto-detection system in the PON provider's server that monitors PON signal transmission through the PON access network; and
e) an auto-assignment system in the PON provider's server that assigns an ONT to the customer through the PON access network and reassigns an ONT to the customer through the PON access network or the Internet;
wherein, when the primary path is in an ON configuration, a PON signal is transmitted to the secondary splitter through the primary path, the protection path is in an OFF configuration, and PON signal is not transmitted to the secondary splitter through the protection path and wherein, when the primary path is in an OFF or disrupted configuration, a PON signal is not transmitted to the secondary splitter through the primary path, the protection path is in an ON configuration, and a PON signal is transmitted to the secondary splitter through the protection path.

7. The software-defined redundant passive optical network system of claim 6, wherein the autodetection system automatically detects a connection of an ONT to the PON access network and the customer's equipment.

8. The software-defined redundant passive optical network system of claim 6, wherein the ONT automatically transmits information, including the customer's unique identifier, from an installer to a provisional portal in the PON provider's server and PON services are provisioned to the ONT.

9. The software-defined redundant passive optical network system of claim 6, wherein the auto-assignment system reassigns another ONT to the customer through the primary path or the protection path, over the PON access network or the Internet using the customer's unique identifier.

10. A software-defined redundant passive optical network system, comprising:
a) a passive optical network (PON) provider's server having a PON access network;
b) the PON access network having a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to customer equipment to receive PON services;
c) the PON access network having one or more protection paths, each protection path extending to an OLT in a protection access node, a feeder fiber extending from the OLT in the protection access node to a protection splitter, two or more distribution fibers extending from the protection splitter to the two or more secondary splitters;
d) an auto-detection system in the PON provider's server that monitors PON signal transmission through the PON access network, wherein the autodetection system automatically detects a connection of an ONT to the PON access network and the customer's equipment; and
e) an auto-assignment system in the PON provider's server that assigns an ONT to the customer through the PON access network and reassigns an ONT to the customer through the PON access network or the Internet;
wherein, when the primary path is in an ON configuration, a PON signal is transmitted to the secondary splitter through the primary path, the protection path is in an OFF configuration, and PON signal is not transmitted to the secondary splitter through the protection path and wherein, when the primary path is in an OFF or disrupted configuration, a PON signal is not transmitted to the secondary splitter through the primary path, the protection path is in an ON configuration, and a PON signal is transmitted to the secondary splitter through the protection path.

11. The software-defined redundant passive optical network system of claim 10, wherein the ONT automatically transmits information, including the customer's unique identifier, from an installer to a provisional portal in the PON provider's server and PON services are provisioned to the ONT.

12. The software-defined redundant passive optical network system of claim 10, wherein the auto-assignment system reassigns another ONT to the customer through the primary path or the protection path, over the PON access network or the Internet using the customer's unique identifier.

13. A software-defined redundant passive optical network system, comprising:
a) a passive optical network (PON) provider's server having a PON access network;
b) the PON access network having a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to customer equipment to receive PON services;
c) the PON access network having one or more protection paths, each protection path extending to an OLT in a protection access node, a feeder fiber extending from the OLT in the protection access node to a protection splitter, two or more distribution fibers extending from the protection splitter to the two or more secondary splitters;
d) an auto-detection system in the PON provider's server that monitors PON signal transmission through the PON access network, wherein the autodetection system automatically detects a connection of an ONT to the PON access network and the customer's equipment and wherein the ONT automatically transmits information, including the customer's unique identifier, from an installer to a provisional portal in the PON provider's server and PON services are provisioned to the ONT; and
e) an auto-assignment system in the PON provider's server that assigns an ONT to the customer through the PON access network and reassigns an ONT to the customer through the PON access network or the Internet;
wherein, when the primary path is in an ON configuration, a PON signal is transmitted to the secondary splitter through the primary path, the protection path is in an OFF configuration, and PON signal is not transmitted to the secondary splitter through the protection path and wherein, when the primary path is in an OFF or disrupted configuration, a PON signal is not transmitted to the secondary splitter through the primary path, the protection path is in an ON configuration, and a PON signal is transmitted to the secondary splitter through the protection path.

14. The software-defined redundant passive optical network system of claim 13, wherein the auto-assignment system reassigns another ONT to the customer through the primary path or the protection path, over the PON access network or the Internet using the customer's unique identifier.

15. A method of auto-assigning passive optical network (PON) services to a customer, comprising the steps of:
1. providing a software-defined redundant passive optical network system, comprising:
a) a PON provider's server having a PON access network;
b) the PON access network having a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to a customer's equipment to receive a PON signal and PON services;
c) the PON access network having one or more protection paths, each protection path extending to an OLT in a protection access node, a feeder fiber extending from the OLT in the protection access node to a protection splitter, two or more distribution fibers extending from the protection splitter to the two or more secondary splitters;
d) an auto-detection system in the PON provider's server that monitors PON signal transmission through the PON access network; and
e) an auto-assignment system in the PON provider's server that assigns an ONT to the customer through the PON access network using a customer's unique identifier;
2) providing an ONT to a customer and connecting the ONT to the PON provider's server PON access network;
3) automatically detecting the connecting of the ONT with the auto-detection system and provisioning a data path between the customer's ONT and a provisional portal by the PON provider's server;
4) accessing the provisional portal through the customer's ONT over the PON access network, entering the customer's unique identifier on the provisional portal, submitting the customer's unique identifier to the PON provider's server, and requesting provisioning of the customer's ONT for PON services;
5) provisioning by the PON provider's server the customer's ONT and the PON access network and connecting the customer's ONT to the PON services; and
6) connecting the customer's equipment to the customer's ONT and activating the PON services for the customer.

16. The method of claim 15, wherein, when the primary path is in an ON configuration, a PON signal is transmitted to the secondary splitter through the primary path, the protection path is in an OFF configuration, and PON signal is not transmitted to the secondary splitter through the protection path and wherein, when the primary path is in an OFF or disrupted configuration, a PON signal is not transmitted to the secondary splitter through the primary path, the protection path is in an ON configuration, and a PON signal is transmitted to the secondary splitter through the protection path.

17. The method of claim 15, wherein the auto-assignment system reassigns another ONT to the customer through the primary path or the protection path, over the PON access network or the Internet using the customer's unique identifier.

18. The method of claim 15, further comprising automated toggling the protection path to an ON position by the auto-assignment system when a loss of signal from the customer's ONT is detected by the automatic detection system.

19. The method of claim 15, further comprising, when a loss of signal is detected from the customer's ONT by the automatic detection system, discovering by the automatic detection system any distribution fiber that is not in a service mode and automatically provisioning the discovered fiber for the customer's ONT using the customer's unique identifier and the auto-assignment system.

20. A method of auto-assigning passive optical network (PON) services to a customer, comprising the steps of:
1. providing a software-defined redundant passive optical network system, comprising:
a) a PON provider's server having a PON access network;
b) the PON access network having a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to a customer's equipment to receive a PON signal and PON services;
c) the PON access network having one or more protection paths, each protection path extending to an OLT in a protection access node, a feeder fiber extending from the OLT in the protection access node to a protection splitter, two or more distribution fibers extending from the protection splitter to the two or more secondary splitters;
d) an auto-detection system in the PON provider's server that monitors PON signal transmission through the PON access network; and
e) an auto-assignment system in the PON provider's server that assigns an ONT to the customer through the PON access network using a customer's unique identifier,
wherein, when the primary path is in an ON configuration, a PON signal is transmitted to the secondary splitter through the primary path, the protection path is in an OFF configuration, and PON signal is not transmitted to the secondary splitter through the protection path,
wherein, when the primary path is in an OFF or disrupted configuration, a PON signal is not transmitted to the secondary splitter through the primary path, the protection path is in an ON configuration, and a PON signal is transmitted to the secondary splitter through the protection path, and wherein the auto-assignment system reassigns another ONT to the customer through the primary path or the protection path, over the PON access network or the Internet using the customer's unique identifier;
2) providing an ONT to a customer and connecting the ONT to the PON provider's server PON access network;
3) automatically detecting the connecting of the ONT with the auto-detection system and provisioning a data path between the customer's ONT and a provisional portal by the PON provider's server;
4) accessing the provisional portal through the customer's ONT over the PON access network, entering the customer's unique identifier on the provisional portal, submitting the customer's unique identifier to the PON provider's server, and requesting provisioning of the customer's ONT for PON services;
5) provisioning by the PON provider's server the customer's ONT and the PON access network and connecting the customer's ONT to the PON services; and
6) connecting the customer's equipment to the customer's ONT and activating the PON services for the customer.

21. The method of claim 20, further comprising automated toggling the protection path to an ON position by the auto-assignment system when a loss of signal from the customer's ONT is detected by the automatic detection system.

22. The method of claim 20, further comprising, when a loss of signal is detected from the customer's ONT by the automatic detection system, discovering by the automatic detection system any distribution fiber that is not in a service mode and automatically provisioning the discovered fiber for the customer's ONT using the customer's unique identifier and the auto-assignment system.

23. A method of auto-assigning passive optical network (PON) services to a customer, comprising the steps of:
1. providing a software-defined redundant passive optical network system, comprising:
a) a PON provider's server having a PON access network;
b) the PON access network having a primary path to an optical line terminal (OLT) in a primary access node, a feeder fiber extending from the OLT in the primary access node to a primary splitter, two or more distribution fibers extending from the primary splitter to two or more secondary splitters, and the two or more secondary splitters each connected to an optical network terminal (ONT), wherein the ONT is configured for connection to a customer's equipment to receive a PON signal and PON services;
c) the PON access network having one or more protection paths, each protection path extending to an OLT in a protection access node, a feeder fiber extending from the OLT in the protection access node to a protection splitter, two or more distribution fibers extending from the protection splitter to the two or more secondary splitters;
d) an auto-detection system in the PON provider's server that monitors PON signal transmission through the PON access network; and
e) an auto-assignment system in the PON provider's server that assigns an ONT to the customer through the PON access network using a customer's unique identifier,
wherein, when the primary path is in an ON configuration, a PON signal is transmitted to the secondary splitter through the primary path, the protection path is in an OFF configuration, and PON signal is not transmitted to the secondary splitter through the protection path,
wherein, when the primary path is in an OFF or disrupted configuration, a PON signal is not transmitted to the secondary splitter through the primary path, the protection path is in an ON configuration, and a PON signal is transmitted to the secondary splitter through the protection path, and
wherein the auto-assignment system reassigns another ONT to the customer through the primary path or the protection path, over the PON access network or the Internet using the customer's unique identifier;
2) providing an ONT to a customer and connecting the ONT to the PON provider's server PON access network;
3) automatically detecting the connecting of the ONT with the auto-detection system and provisioning a data path between the customer's ONT and a provisional portal by the PON provider's server;
4) accessing the provisional portal through the customer's ONT over the PON access network, entering the customer's unique identifier on the provisional portal, submitting the customer's unique identifier to the PON provider's server, and requesting provisioning of the customer's ONT for PON services;
5) provisioning by the PON provider's server the customer's ONT and the PON access network and connecting the customer's ONT to the PON services;
6) connecting the customer's equipment to the customer's ONT and activating the PON services for the customer;
7) automated toggling the protection path to an ON position by the auto-assignment system when a loss of signal from the customer's ONT is detected by the automatic detection system; and
8) when a loss of signal is detected from the customer's ONT by the automatic detection system, discovering by the automatic detection system any distribution fiber that is not in a service mode and automatically provisioning the discovered fiber for the customer's ONT using the customer's unique identifier and the auto-assignment system.
